(19) United States
(12) Patent Application Publication
(10) Pub. No.: US 2015/0021202 A1
(43) Pub. Date: Jan. 22, 2015

(54) Device and Method for Electrochemical Gas Sensing

(71) Applicant: Stichting IMEC Nederland, Eindhoven (NL)

(72) Inventors: Jozef Franciscus Maria Oudenhoven, Eindhoven (NL); Greja Johanna Adriana Maria Verheyden, Dommelen (NL); Marcel Arie Günther Zevenbergen, Rotterdam (NL)

(73) Assignee: Stichting IMEC Nederland, Eindhoven (NL)

(21) Appl. No.: 14/334,165

(22) Filed: Jul. 17, 2014

(30) Foreign Application Priority Data
Jul. 19, 2013 (EP) 13177256.8

(51) Int. Cl. G01N 27/403

(52) U.S. Cl. CPC G01N 27/403
USPC 205/775; 204/431

(57) ABSTRACT

The disclosure relates to a device for electrochemical gas sensing, comprising a plurality of different electrodes and a freestanding electrolyte film covering said electrodes, wherein at least two of those electrodes present a different distance from its top surface to the electrolyte film surface. The disclosure also relates to an electronic system and a method for electrochemical gas sensing.

### CROSS-REFERENCE TO RELATED APPLICATIONS

This application claims priority to European Patent Application No. 13177256.8, filed on Jul. 19, 2013, the contents of which are hereby incorporated by reference.

### TECHNICAL FIELD

The present disclosure relates generally to the field of electrochemical sensors, and more specifically to a device and a method for electrochemical gas sensing comprising a freestanding electrolyte film.

### BACKGROUND

Electrochemical sensors, e.g., sensors for the sensing of gasses, are based on the principle of electrochemical reactions that occur in an electrochemical cell into which the gasses that need to be detected dissolve. An electrochemical cell generally consists of two or more electrodes, at which electrochemical reactions occur and currents are generated that can be measured. If an appropriate voltage is applied, the currents scale with the amount of the gas to be determined. To be able to operate, all electrodes have to be on one side connected to an electrical circuit, and in the electrochemical cell these need to be in contact with a continuous (liquid) medium that is capable of transporting ions. This medium is denominated as electrolyte, and usually consists of liquid containing ions, i.e., a salt solution or an ionic liquid. Ionic liquids are preferred for this application because these possess the property that these have a negligible vapour pressure, and will therefore not evaporate.

A known electrochemical sensor in the art comprising a porous membrane is described in US patent application 2010/0133120 A1. Further electrochemical sensors in the art comprising a membrane-free electrolyte are described in paper “Electronic Sensing of Ethylene Employing a Thin Ionic-Liquid Layer”, Zevenbergen et al., Analytical Chemistry, 2011, 83 (16), pp 6300-6307, and in European patent application EP 2 506 001 A1.

### SUMMARY

According to exemplary embodiments of the disclosure, an improved device and method for electrochemical gas sensing is provided with higher sensing sensitivity.

According to an exemplary embodiment of the disclosure there is provided a device for electrochemical gas sensing comprising a plurality of different electrodes and a freestanding electrolyte film covering those electrodes, and wherein at least two of those electrodes present a different distance from its top surface to the electrolyte film surface. At least one of the electrodes may be configured to serve as a pillar structure to keep the freestanding electrolyte film stable without film rupture. The height of one of the electrodes may be selected such that the distance from its top surface to the freestanding electrolyte film's surface is at least 25% less than the total electrolyte film thickness. The height of one of the electrodes may be equal or less than 25 μm, and preferably around 5 μm.

According to another exemplary embodiment, at least one of the electrodes may comprise pillar structures. The pillar structures may comprise a non-conductive pillar covered completely or partially with an electrode material. The pillar structures have a width in a range between 1 μm to 100 μm and preferably around 10 μm. The pillar structures may be placed at a distance between each other in a range between 1 μm to 50 μm, and preferably around 10 μm. The distance between the pillar structures depends on the properties of the freestanding electrolyte film and is selected such that the freestanding electrolyte film is stable and without rupture.

According to another exemplary embodiment, the device comprises at least one working electrode and a reference electrode placed over a non-conductive substrate and the height of the at least one working electrode's top surface in the direction perpendicular to the non-conductive substrate is greater than that of the reference electrode's top surface. The height of the at least one working electrode's top surface in the direction perpendicular to the non-conductive substrate may be at least twice that of the reference electrode's top surface.

According to another exemplary embodiment, the device comprises a first working electrode configured for reacting with at least a first molecule and a second working electrode configured for reacting with a second molecule and the height of the second working electrode's top surface in the direction perpendicular to the non-conductive substrate is greater than the height of the of the first working electrode's top surface.

According to another exemplary embodiment, at least one electrode comprises separated pillar structures.

According to another exemplary embodiment, the electrodes are positioned in an interdigitated layout.

The disclosure also relates to an electronic system comprising a device for electrochemical gas sensing according to any of the embodiments herein described. The electronic system may further comprise heating or cooling means for keeping the device for electrochemical gas sensing at a certain working temperature.

The disclosure further relates to a method for electrochemical gas sensing comprising exposing a device according to any of the embodiments herein described to a gas medium. The method may further comprise heating or cooling of the device for keeping it at a certain working temperature.

Certain objects and advantages of various new and inventive aspects have been described above. It is to be understood that not necessarily all such objects or advantages may be achieved in accordance with any particular embodiment of the present disclosure. Those skilled in the art will recognize that the solution of the present disclosure may be embodied or carried out in a manner that achieves or optimizes one advantage or group of advantages without necessarily achieving other objects or advantages.

### BRIEF DESCRIPTION OF THE DRAWINGS

The above and other aspects of the device and a method for electrochemical gas sensing according to the present disclosure will be shown and explained with reference to the non-restrictive example embodiments described hereinafter.

FIG. 1 shows a cross-sectional view of a device for electrochemical gas sensing according to a first exemplary embodiment of the disclosure.

FIG. 2 shows a top view of a device for electrochemical gas sensing according to a second exemplary embodiment of the disclosure.

FIG. 3 shows a top view of a device for electrochemical gas sensing according to a third exemplary embodiment of the disclosure.

FIG. 4 shows a cross-sectional view of a device for electrochemical gas sensing according to a fourth exemplary embodiment of the disclosure.

FIG. 5 shows a cross-sectional view of a device for electrochemical gas sensing according to a fifth exemplary embodiment of the disclosure.

FIG. 6 shows a cross-sectional view of a device for electrochemical gas sensing according to a sixth exemplary embodiment of the disclosure.

FIG. 7 illustrates a graph of the cross-sectional thickness profile of a device for electrochemical gas sensing according to a seventh exemplary embodiment of the disclosure.

FIG. 8 illustrates a graph of the sensitivity for gas sensing of a device according to an exemplary embodiment of the disclosure.

FIG. 9 illustrates a graph of the sensitivity for gas sensing of a state of the art electrochemical gas sensor.

FIG. 10 shows a top view of a device for electrochemical gas sensing according to an exemplary embodiment of the disclosure.

FIG. 11 shows a cross-sectional view of a device for electrochemical gas sensing according to an exemplary embodiment of the disclosure.

FIG. 12 shows a cross-sectional view of a device for electrochemical gas sensing according to an exemplary embodiment of the disclosure.

### DETAILED DESCRIPTION

In the following, in the description of exemplary embodiments, various features may be grouped together in a single embodiment, figure, or description thereof for the purpose of streamlining the disclosure and aiding in the understanding of one or more of the various inventive aspects. This is however not to be interpreted as the disclosure requiring more features than the ones expressly recited in the main claim. Furthermore, combinations of features of different embodiments are meant to be within the scope of the disclosure, as would be clearly understood by those skilled in the art. Additionally, in other instances, well-known methods, structures and techniques have not been shown in detail in order not to obscure an understanding of the description.

FIG. 1 shows a cross-sectional view of an exemplary device 100 for electrochemical gas sensing according to an embodiment of the disclosure, comprising a non-conductive substrate 7, a working electrode 4, a counter electrode 6, a reference electrode 5 and an electrolyte or ionic liquid film 3 covering the electrodes.

According to an exemplary embodiment, the working electrode 4 is elevated compared to the other electrodes 5, 6, that is, the working electrode 4 is higher or has a greater height H in the direction perpendicular to the substrate surface. In this way, the working electrode top surface 4a is located at a closer distance D to the ionic liquid film surface 3a or electrolyte-gas interface, than the other electrode's top surfaces 5a, 6a.

In operation, a gas medium 1 comprising a gas molecule 2 that wants to be detected will dissolve in the electrolyte 3, as depicted by trajectory 2i, and subsequently react with the top surface 4a of the working electrode 4, which will serve for detection of such gas molecule. The working or sensing electrode 4 is maintained at a potential at which the gas molecule 2 will react, and is set with respect to the reference electrode 5. A third electrode serves as counter electrode 6.

According to an exemplary embodiment of the disclosure, the distance D between the electrolyte-gas interface 3a, where the gas is dissolved, and the electrolyte-working electrode interface, where said gas will react, is decreased. According to an exemplary embodiment of the disclosure, the device 100 for electrochemical gas sensing is configured such that the working electrode top surface 4a is brought closer to the electrolyte-gas interface 3a.

According to an exemplary embodiment of the disclosure, the device 100 for electrochemical gas sensing is configured such that the working electrodes also serve as pillars to keep the ionic liquid film 3 stable, without film rupture. This will be beneficial to prevent rupturing of the electrolyte film at the electrode surface, because the top area covered with a thin layer of electrolyte will be smaller. When a large area is covered by a too thin film, it will rupture and form individual droplets. Advantageously, the sensitivity of the device 100 can be increased, without the need to thin down the ionic liquid film 3. The liquid film may have a thickness in the range of 0.1 to 100 μm. The basis for the gas detection is an electrochemical reaction at which electrons are released (or consumed), which can be accurately measured as a current. To improve the sensitivity of the sensor, the ratio of the number of detectable molecules in the gas medium 1 to the number of molecules that react at the electrode should be as high as possible. This is achieved, according to an exemplary embodiment, by decreasing the transport distance D from the gas medium 1 through the electrolyte 3 to the working electrode top surface 4a.

According to exemplary embodiments, the height H of reference electrode 5 and counter electrode 6 may be in the range of 50 to 500 nm, typically 150 to 250 nm, and that of the working electrode 4 in the range of 300 nm to 50 μm. According to another exemplary embodiment, the height H of the working electrode 4 is selected such that the distance D from its top surface 4a to the ionic liquid surface 3a is at least 25% less than the total ionic liquid film thickness (from the ionic liquid film surface 3a to the substrate's surface 7a) and equal or less than 25 μm, and preferably around 5 μm. According to another exemplary embodiment, the height H of the working electrode 4 is at least twice the height H of the reference electrode 5.

It shall be understood that although in the figure, the distance D to the electrolyte film surface 3a is shown in relation just to the working electrode's top surface 4a, in general, such distance D could also be shown in relation to the top surface of any of the other electrodes. In the same way, although the height H from the substrate's surface 7a is shown in relation just to the working electrode's top surface 4a, in general, such height H could also be shown in relation to the top surface of any of the other electrodes. It shall be also understood that the device 100 for electrochemical gas sensing does not necessarily need three electrodes for sensing. According to other exemplary embodiments, the device 100 for electrochemical gas sensing comprises just two electrodes, a working electrode 4 and a counter electrode 6 which can also function as a reference electrode, and the working electrode 4 is elevated compared to the counter electrode 6.

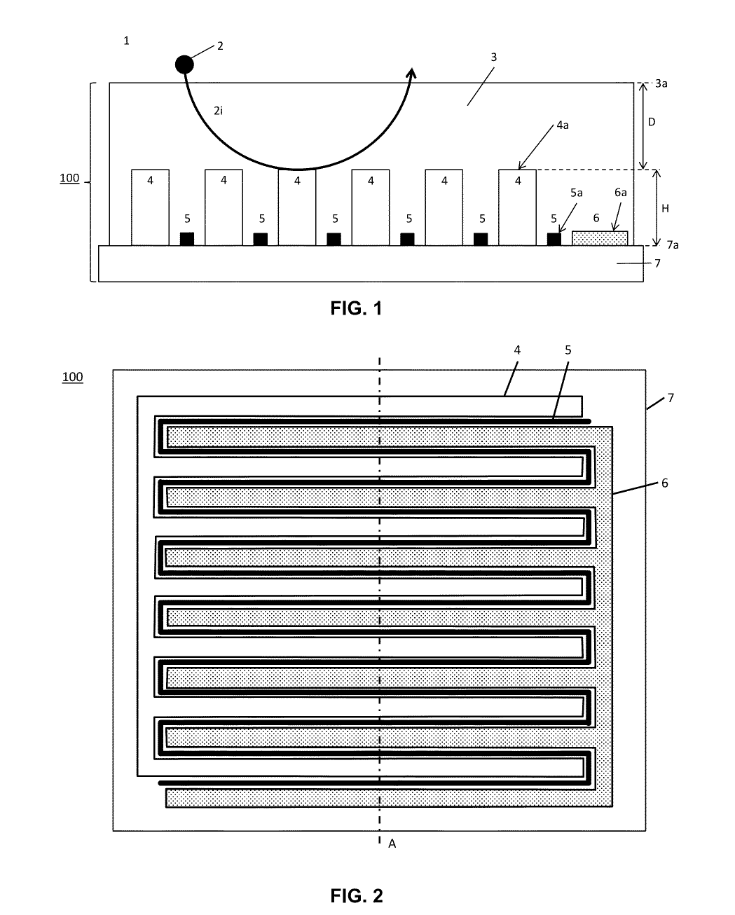

FIG. 2 shows a top view of a device 100 for electrochemical gas sensing comprising a non-conductive substrate 7, a working electrode 4, a counter electrode 6, a reference electrode 5. The ionic liquid film is not shown, but it is understood that it will be located on top of the substrate, covering all the electrodes. The electrodes are positioned in an interdigitated layout. In the exemplary embodiment, the working electrode 4 and the counter electrode 6 are relatively wide, and may be used as current carrying electrodes. The reference electrode 5 is designed as a thin serpentine electrode that meanders between the interdigitated sensing electrode 4 and counter electrode 6.

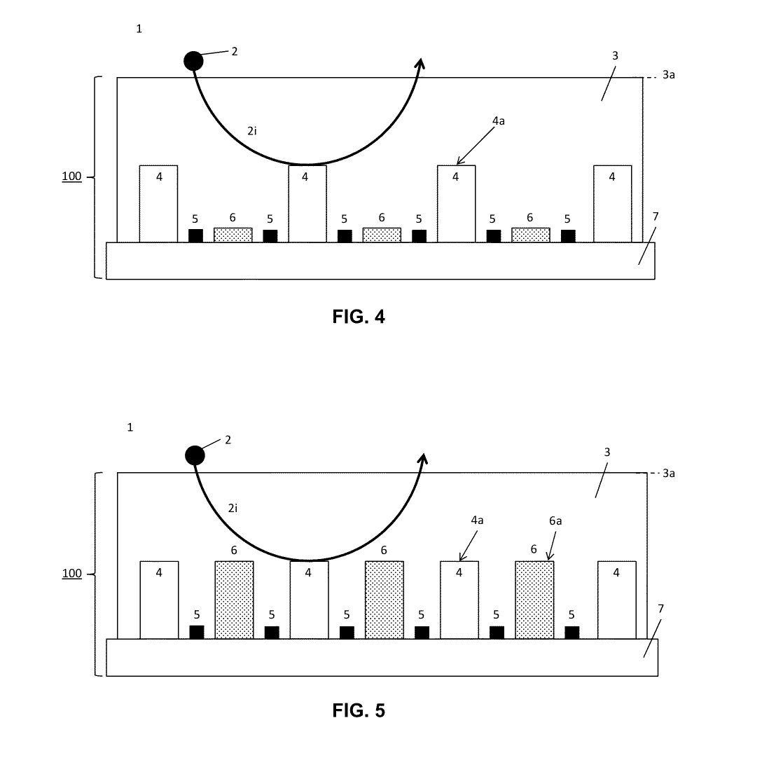

An exemplary cross-sectional view, along axis A, of the device 100 of FIG. 2 can be seen in FIG. 4. In this exemplary embodiment the working electrode surface 4a is elevated and brought closer to the ionic liquid film surface 3a. Another exemplary cross-sectional view, along axis A, of the device 100 of FIG. 2 can be seen in FIG. 5. In this exemplary embodiment both the working electrode surface 4a and the counter electrode surface 6a are elevated and brought closer to the ionic liquid film surface 3a. Advantageously, in this way, further support and stability of the ionic liquid film 3 is achieved and/or acceleration of the sensing and the counter reactions.

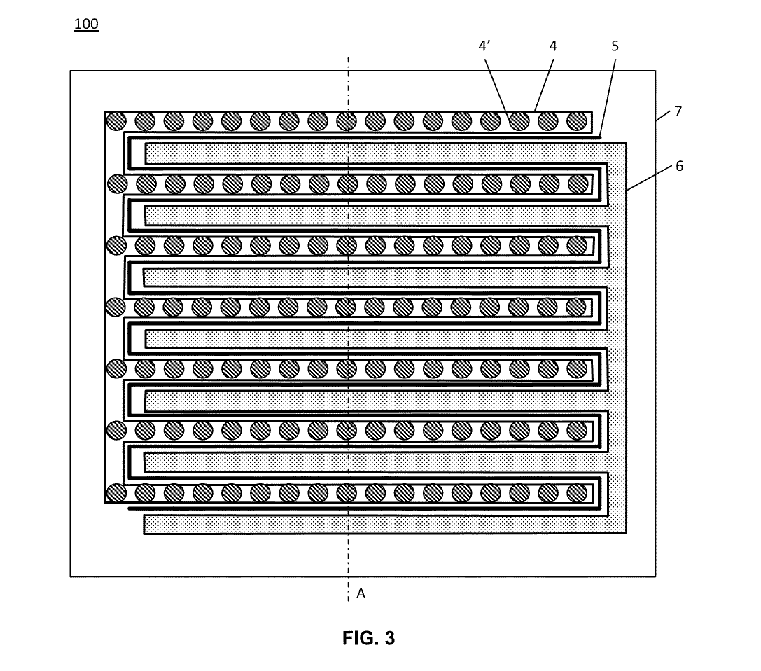

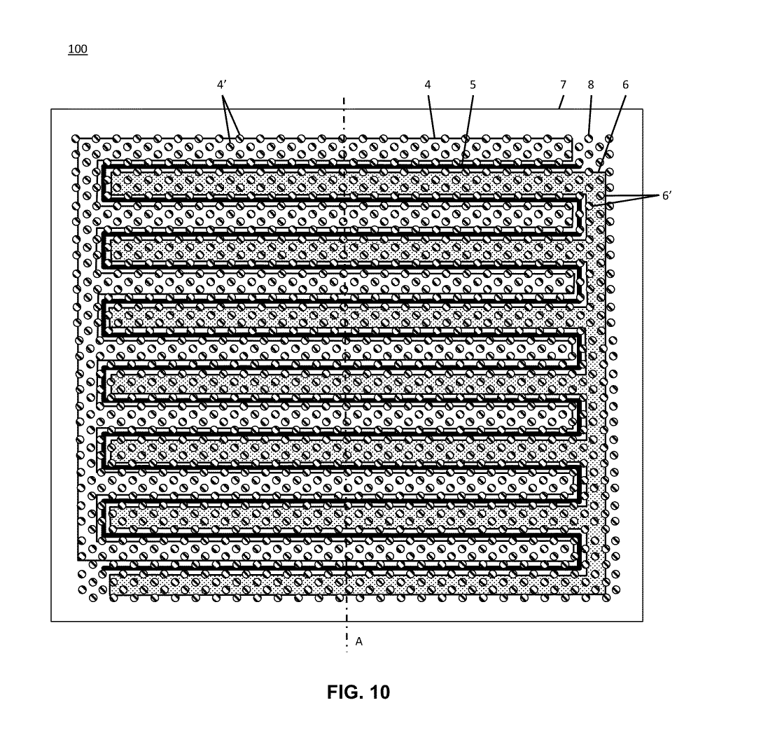

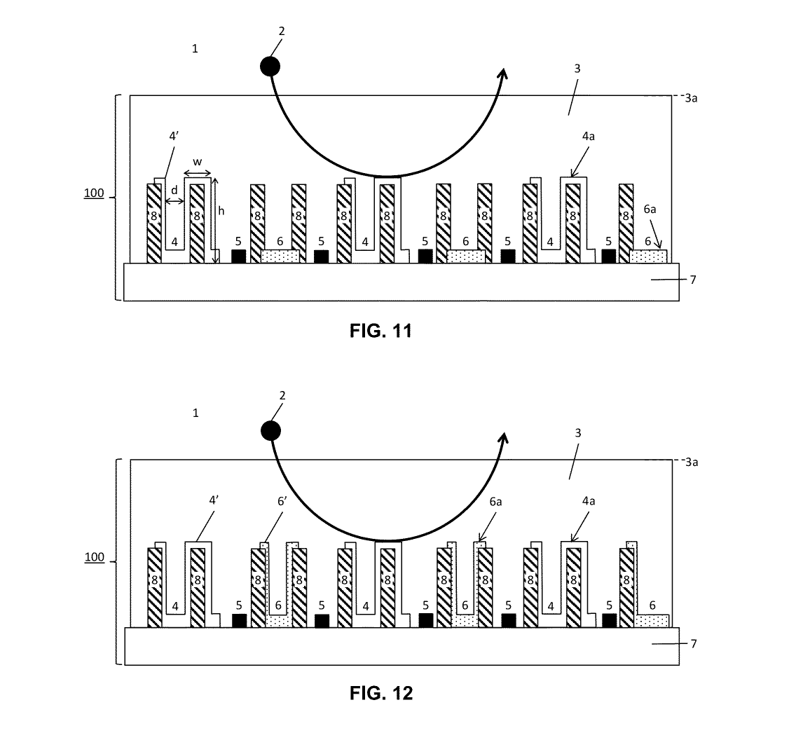

FIG. 3 shows a top view of another exemplary device 100 for electrochemical gas sensing comprising a non-conductive substrate 7, a working electrode 4, a counter electrode 6, a reference electrode 5. The ionic liquid film is not shown, but it is understood that it will be located on top of the substrate, covering all the electrodes. The electrodes are positioned in an interdigitated layout. In the exemplary embodiment, only some parts of the working electrode 4 are elevated, for example, the working electrode 4 may comprise pillar structures 4′, separate cylindrical pillar structures as in the figure, or rectangular, which are made of or covered with the electrode material. Advantageously, adding pillars is beneficial not only for bringing the electrode surface closer to the ionic liquid film surface, but also, when designing its distribution, for keeping a larger part of the liquid film relatively thick and/or improve the stability of the liquid film. The use of pillars may reduce the cost of the device due to the use of less material. Furthermore, the use of pillars allows for an acceleration of the sensing and the counter reactions. Exemplary cross-sectional views, along axis A, of the device 100 of FIG. 3 can be seen also in FIG. 4 and FIG. 5. As shown in FIG. 10 the counter electrode 6 may also comprise pillar structures 6′ that contribute to the freestanding electrolyte film stability. Similarly, although not shown, it shall be understood that the reference electrode 5 may also comprise pillar structures. According to another exemplary embodiment, also shown in FIG. 10, the device may comprise further non-conductive pillar structures 8 placed on the substrate which contribute to the freestanding electrolyte film stability. An exemplary cross-sectional view, along axis A, of the device 100 of FIG. 10 can be seen in FIG. 11 and FIG. 12. In the exemplary embodiment of FIG. 11, the working electrode 4 comprises non-conductive pillar structures 8 placed on top of the substrate 7 and covered with an electrode material. The electrode material may cover the pillar structures 8 completely or partially. The working electrode surface 4a is elevated and brought closer to the ionic liquid film surface 3a. In the exemplary embodiment of FIG. 12, both the working electrode 4 and the counter electrode 6 comprise non-conductive pillar structures 8 covered completely or partially with an electrode material. In this exemplary embodiment, both the working electrode surface 4a and the counter electrode surface 6a are elevated and brought closer to the ionic liquid film surface 3a. Advantageously, in this way, further support and stability of the ionic liquid film 3 is achieved and/or acceleration of the sensing and the counter reactions. In the embodiments of FIG. 11 and FIG. 12, the reference electrode 5 is shown as placed between non-conductive pillar structure 8. However, it should be understood that the reference electrode 5 may comprise conductive pillar structures or non-conductive pillar structures 8 covered completely or partially with electrode material.

According to an exemplary embodiment, the width w of the pillars structures 4′, 6′, 8 may be from 1 μm to 100 μm, and preferably around 10 μm. The distance d between the pillar structures is defined by the properties of the electrolyte liquid 3 and should be chosen such that a stable liquid film may be formed. According to an exemplary embodiment, the distance d between the pillar structures may be from 1 μm to 50 μm, and preferably 10 μm. Advantageously, the use of narrower pillar structures allows for simpler manufacturing of the device. According to another exemplary embodiment, the height h of the pillar structures 4′, 6′, 8 is selected such that the distance D from their top surface 4a, 6a to the ionic liquid surface 3a is at least 25% less than the total ionic liquid film thickness (from the ionic liquid film surface 3a to the substrate's surface 7a) and up to 25 μm, and preferably around 5 μm.

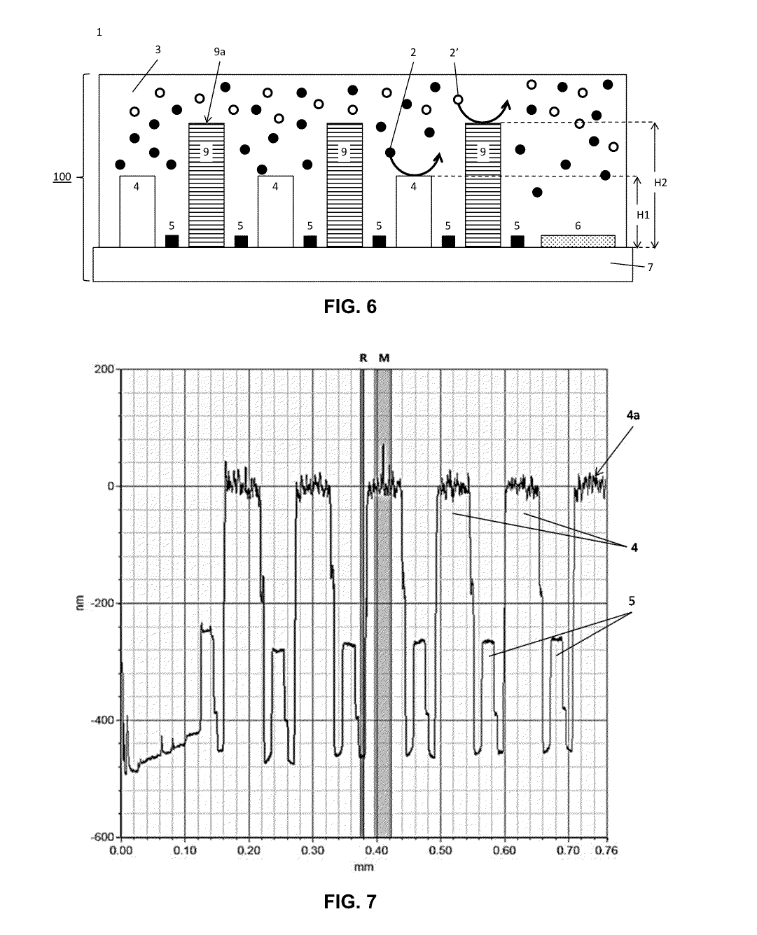

FIG. 6 shows a cross-sectional view of a device 100 for electrochemical gas sensing comprising a non-conductive substrate 7, a first working electrode 4, a second working electrode 9, a counter electrode 6, a reference electrode 5 and an electrolyte or ionic liquid film 3 covering the electrodes. This exemplary configuration is beneficial in case the first working electrode 4 is sensitive to multiple gas molecules 2, 2′, for example, one that has to be detected 2 and one that is considered an undesired species 2′. In such case, a second working electrode 9 is included that will first remove the undesired gas molecule 2′, so that the sensing electrode 4 may be used to detect the desired gas molecules 2 selectively. In this exemplary embodiment, the height of the second working electrode 9 is greater than that of the first working electrode 4. Advantageously, by mixing working electrodes reacting to different gas molecules and having different or multiple height levels, cross-sensitivity is mitigated and false positive detections are reduced. Multiple electrode levels may be included to remove gasses to which the sensor would otherwise be cross-sensitive.

In operation, in a gas medium 1 comprising a gas molecule 2 that wants to be detected and an undesired molecule 2′ to which the sensing electrode 4 is cross-sensitive, both gases will dissolve in the electrolyte 3. The undesired molecules 2′ will selectively react at the level of the second working electrode 9, so that only the desired gas molecules 2 will reach the first working or sensing electrode 4.

FIG. 7 illustrates a graph of the cross-sectional profile of a device 100 for electrochemical gas sensing similar to the configuration shown in FIG. 1. The graph shows the narrow and lower reference electrodes 5 and the higher and broader working electrodes 4. A counter electrode, not shown, may be positioned around these electrodes. The sensing electrode 4 and the counter electrode 6 may be made of gold and the reference electrode 5 may be made of platinum. In this exemplary embodiment, the sensing electrode 4 has a height of approximately 0.5 μm and the reference electrode of 0.25 μm.

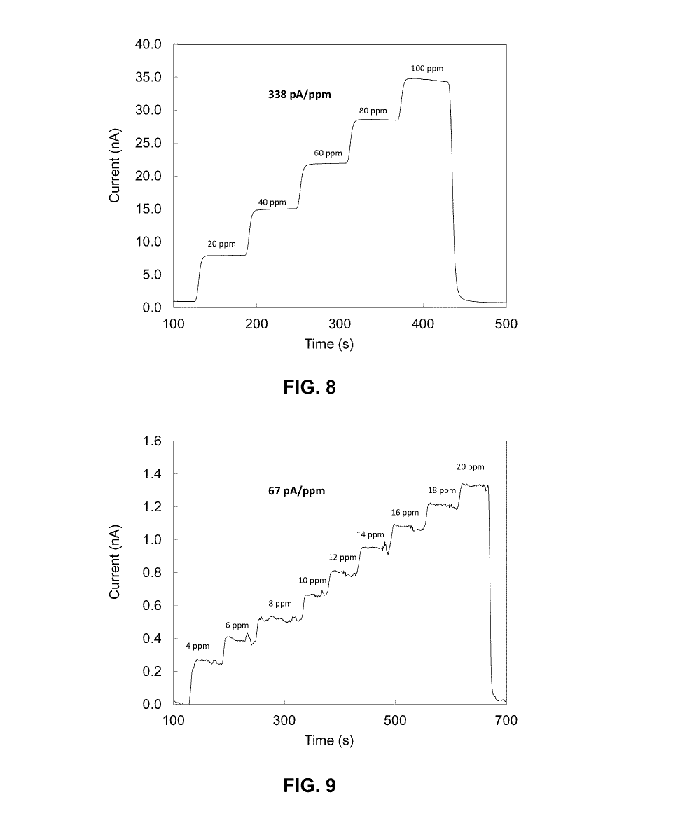

FIG. 8 illustrates a graph of the sensitivity for gas sensing of a device 100 according to an exemplary embodiment of the disclosure, compared to the sensitivity of a state of the art electrochemical gas sensor shown in FIG. 9. The sensitivity of two gas-sensing devices, for example, to ethylene was measured with a sensor according to an exemplary embodiment of the disclosure (FIG. 8) and with a sensor not having elevated sensing electrodes (FIG. 9). The graphs confirm that the sensitivity of a device according to an exemplary embodiment of the disclosure is higher (338 pA/ppm ethylene) than the sensitivity of a state of the art electrochemical sensor (67 pA/ppm ethylene). Current state of the art sensors (with the same electrode layout) with non-elevated working electrodes show a sensitivity in the order of 50-100 pA/ppm.

Advantageously, further embodiments may combine the device 100 for electrochemical gas sensing according to any of the embodiments of the disclosure, with extra electronic circuitry to be integrated in an electronic device system. The electrochemical sensor may be combined with other electronic functions that enhance the sensor performance. In this sense, for example, temperature or humidity sensors may be included or a heating or cooling system may be added for keeping the gas sensing characteristics under certain performance values and/or the sensor at a constant optimal working temperature.

1. A device for electrochemical gas sensing, comprising a plurality of different electrodes and a freestanding electrolyte film covering said electrodes, wherein at least two of those electrodes present a different distance from its top surface to the electrolyte film surface.

2. A device according to claim 1, wherein at least one electrode comprises pillar structures.

3. A device according to claim 2, wherein the pillar structures comprise a non-conductive pillar covered completely or partially with an electrode material.

4. A device according to claim 2, wherein the pillar structures have a width in a range between 1 μm to 100 μm.

5. A device according to any of claim 2, wherein the pillar structures are placed at a distance between each other in a range between 1 m to 50 m.

6. A device according to claim 1, wherein the height of one of the electrodes is selected such that the distance from its top surface to the free-standing electrolyte film's surface is at least 25% less than the total electrolyte film thickness.

7. A device according to claim 6, wherein the height is equal or less than 25 m.

8. A device according to claim 1, comprising at least one working electrode and a reference electrode placed over a non-conductive substrate, wherein the height of the at least one working electrode's top surface in the direction perpendicular to the non-conductive substrate is greater than that of the reference electrode's top surface.

9. A device according to claim 8, wherein the height of the at least one working electrode's top surface in the direction perpendicular to the non-conductive substrate is at least twice that of the reference electrode's top surface.

10. A device according to claim 1, comprising a first working electrode configured for reacting with at least a first molecule and a second working electrode configured for reacting with a second molecule, wherein the height of the second working electrode's top surface in the direction perpendicular to the non-conductive substrate is greater than the height of the of the first working electrode's top surface.

11. A device according to claim 1, wherein the electrodes are positioned in an interdigitated layout.

12. An electronic system comprising a device for electrochemical gas sensing according to claim 1.

13. The electronic system according to claim 12, further comprising heating or cooling means for keeping the device for electrochemical gas sensing at a working temperature.

14. A method for electrochemical gas sensing comprising exposing a device according to claim 1 to a gas medium.

15. A method for electrochemical gas sensing according to claim 14, further comprising heating or cooling of the device for keeping it at a working temperature.
